(19) United States
(12) Patent Application Publication
(10) Pub. No.: US 2012/0129504 A1
(43) Pub. Date: May 24, 2012

(54) APPARATUS AND METHOD FOR PROVIDING SEMANTIC CONTEXT

(75) Inventors: Jong Hoon LEE, Daejeon (KR); Hoon Ki Lee, Daejeon (KR); Jung Tae Kim, Daejeon (KR); Eui Hyun Paik, Daejeon (KR); Dong Won Han, Daejeon (KR)

(73) Assignee: Electronics and Telecommunications Research Institute, Daejeon (KR)

(21) Appl. No.: 13/289,247

(22) Filed: Nov. 4, 2011

(30) Foreign Application Priority Data
Nov. 18, 2010 (KR) 10-2010-0115204

(51) Int. Cl. H04W 4/02

(52) U.S. Cl. 455/414.1

(57) ABSTRACT

A method for providing a semantic context according to an exemplary embodiment of the present invention may include: extracting at least one of address information and surrounding address information of the address information on the basis of a user's location; reading a social relationship list which is a list of people having a social relationship with a user; extracting information associated with people on the read social relationship list in a region corresponding to at least one of the extracted address information and the extracted surrounding address information; and providing the extracted information to the user.

### CROSS-REFERENCE TO RELATED APPLICATIONS

This application claims priority to and the benefit of Korean Patent Application No. 10-2010-0115204 filed in the Korean Intellectual Property Office on Nov. 18, 2010, the entire contents of which are incorporated herein by reference.

### BACKGROUND OF THE INVENTION

1. Field of the Invention

The present invention relates to an apparatus and a method for providing a semantic context that can provide customized information to a user.

2. Description of the Related Art

With the rapid development of smart phones that can provide a location-based service, diversified services using a social network (SNS : Social Network Service, social relationship) are being provided and developed. The social networking service principally provides the social relationship between the users and provides a service to make or maintain the relationship between people.

The user can obtain a service for knowledge sharing, a service for social networking participation, and a service for social networking configuration on the basis of the service.

Meanwhile, the location-based service enables retrieval of surrounding information in the vicinity of a current location obtained by using a GPS module mounted on a mobile phone. In recent years, with the rapid development and propagation of the smart phones, the location-based service has been developed to an application type that provides various contents on the basis of the user's positional information.

However, the location-based service is limited in that it should show only contents corresponding to a category selected through user's specified selection of the category or output all surrounding lists.

### SUMMARY OF THE INVENTION

The present invention has been made in an effort to provide a method of providing optimal information to a user by combining user's social relationship information with user's positional information.

An exemplary embodiment of the present invention provides an apparatus for providing a semantic context, the apparatus including: a user's location tracking unit extracting at least one of address information and surrounding address information of the address information on the basis of a user's location; a user preference managing unit reading a social relationship list which is a list of people having a social relationship with the user; a semantic use needs inferring unit extracting a query word which people on the read social relationship list query in a region corresponding to at least one of the extracted address information and the extracted surrounding address information; and a result providing unit providing the extracted query word to the user.

The user preference managing unit may extract a predetermined location which people on the read social relationship list visit in the region corresponding to at least one of the extracted address information and the surrounding address information, and the result outputting unit may provide the extracted predetermined location to the user.

The apparatus may further include an event managing unit managing event information for the predetermined location and the result outputting unit may additionally provide the event information for the predetermined location.

Another exemplary embodiment of the present invention provides an apparatus for providing a semantic context, the apparatus including: a user's location tracking unit extracting at least one of address information and surrounding address information of the address information on the basis of a user's location; a semantic location information managing unit extracting category classification for a predetermined location which exists in a region corresponding to at least one of the address information and the surrounding address information of the address information and extracting at least one objective of the category classification; and a user preference managing unit extracting an objective most suitable for a user among at least one objective of the category classification on the basis of the user's profile.

The user's profile may include at least one piece of information of an age, an occupation, and an interest of the user.

Yet another exemplary embodiment of the present invention provides a method for providing a semantic context, the method including: extracting at least one of address information and surrounding address information of the address information on the basis of a user's location; reading a social relationship list which is a list of people having a social relationship with a user; extracting information associated people on the read social relationship list in a region corresponding to at least one of the extracted address information and the extracted surrounding address information; and providing the extracted information to the user.

The extracting of the associated information may include extracting a query word which people on the read social relationship list query in the region corresponding to at least one of the extracted address information and the extracted surrounding address information.

The extracting of the associated information may include extracting a predetermined location which people on the social relationship list visit in the region corresponding to at least one of the extracted address information and the extracted surrounding address information.

In addition, the method may further include additionally providing event information for the predetermined location to the user.

Still another exemplary embodiment of the present invention provides an apparatus for providing a semantic context, the apparatus including: a social relationship repository storing a social relationship list which is a list of people having a social relationship with a predetermined user; and a location repository storing predetermined location information, address information corresponding to the predetermined location information, surrounding address information of the address information, and a predetermined location which people on the social relationship list visit in a region corresponding to at least one of the address information and the surrounding address information.

The apparatus may further include a query word repository storing a query word which people on the read social relationship list query in the region corresponding to at least one of the extracted address information and the extracted surrounding address information.

The present invention provides the following effects.

First, a customized location-based service can be provided to a user by providing semantic context processing technology using a user's location and a user's social relationship.

Second, various types of intelligent social media services can be provided by providing a context on the basis of various profiles, interests, social relationships of the user as compared with a location-based service or an application on the basis of the existing static category or people retrieval.

### BRIEF DESCRIPTION OF THE DRAWINGS

FIG. 1 is a diagram illustrating a semantic context providing model using a positional/social relationship according to an exemplary embodiment of the present invention;

FIG. 2 is a block diagram of a semantic context providing apparatus according to an exemplary embodiment of the present invention;

FIG. 3 is a diagram illustrating an exemplary embodiment of a location repository of FIG. 2; and

FIG. 4 is a flowchart illustrating a semantic context providing method according to an exemplary embodiment of the present invention.

### DETAILED DESCRIPTION OF THE EMBODIMENTS

In exemplary embodiments described below, components and features of the present invention are combined with each other in a predetermined pattern. Each component or feature may be considered to be optional unless stated otherwise. Each component or feature may not be combined with other components or features. Further, some components and/or features are combined with each other to configure the exemplary embodiments of the present invention. The order of operations described in the exemplary embodiments of the present invention may be modified. Some components or features of any exemplary embodiment may be included in other exemplary embodiments or substituted with corresponding components or features of other exemplary embodiments.

The exemplary embodiments of the present invention may be implemented through various means. For example, the exemplary embodiments of the present invention may be implemented by hardware, firmware, software, or combinations thereof.

In the case of implementation by hardware, a method according to the exemplary embodiment of the present invention may be implemented by application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, and the like.

In the case of implementation by firmware or software, the method according to the exemplary embodiments of the present invention may be implemented in the form of a module, a process, or a function of performing the functions or operations described above. Software codes may be stored in a memory unit and driven by a processor. The memory unit is positioned inside or outside of the processor to transmit and receive data to and from the processor by various known means.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Further, term “module” described in the specification imply a unit of processing a predetermined function or operation and can be implemented by hardware or software or a combination of hardware and software.

Predetermined terms used in the following description are provided to help understanding the present invention and the use of the predetermined terms may be modified into different forms without departing from the spirit of the present invention.

Hereinafter, exemplary embodiments of the present invention will be described in detail with reference to the accompanying drawings.

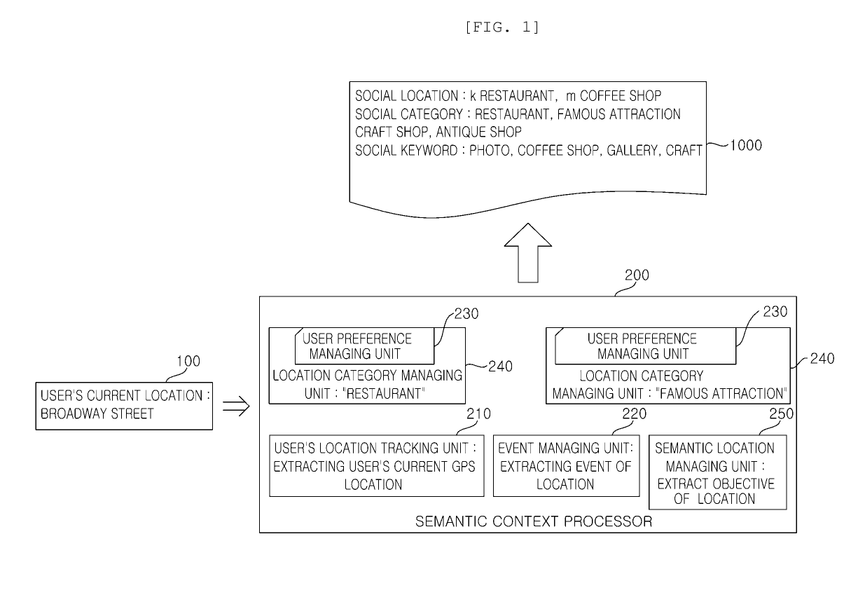

FIG. 1 is a diagram illustrating a semantic context providing model using a positional/social relationship according to an exemplary embodiment of the present invention.

According to the exemplary embodiment, a user's current location 100 is Broadway Street (a example of specified position). According to the exemplary embodiment of the present invention, when a user has a smart phone including a semantic context processor 200, the user may receive social location information, social category information, and social keyword information according to the present invention.

The social location information, the social category information, and the social keyword information are deduced through a user's profile, a visitation record, a search word, a query word, and the like of people that have a social relationship with the user on the basis of the user's current location.

According to the exemplary embodiment, when the user's current location 100 is Broadway Street, a user's location tracking unit 210 of the semantic context processor 200 extract user's current GPS positional information.

In addition, a “restaurant” and a “famous attraction” are recommended to the user as the location category at a current location through a user preference managing unit 230 and a location category managing unit 240 of the semantic context processor 200. The location category recommended to the user becomes the social category information.

Information regarding a predetermined location which people having the social relationship with the user visit at the user's current location is extracted through the user preference managing unit 230 of the semantic context processor 200. The information regarding the predetermined location becomes the social location information.

In addition, event information for the predetermined location extracted from the user preference managing unit 230 is extracted under the control of an event managing unit 220 to be provided to the user.

Further, a user's objective most suitable for the user is extracted from a category classification of a predetermined location or a predetermined region through a semantic location information managing unit 250 in the semantic context processor 200.

In addition, according to the exemplary embodiment, information regarding a search word or a query word which people having the social relationship with the user search at the user's current location is extracted through the semantic context processor 200. The information regarding the search word or the query word becomes the social keyword information.

Consequently, results 1000 provided to the user include a “k restaurant” and an “m coffee shop” which are the social location information, a “restaurant” and a “famous attraction” which are the social category information, and a “photo”, a “coffee shop”, a “gallery”, a “craft” which are the social keyword information.

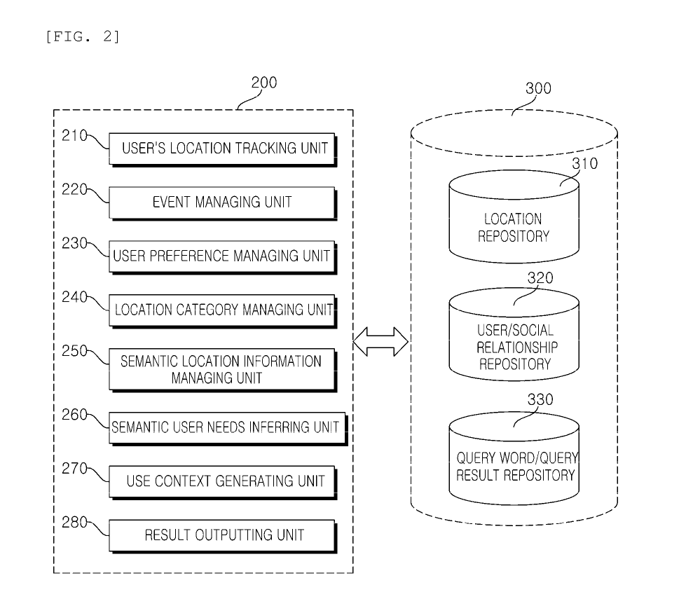

FIG. 2 is a block diagram of a semantic context providing apparatus according to an exemplary embodiment of the present invention.

Referring to FIG. 2, the semantic context providing apparatus may include a semantic context processor 200 and a context repository 300.

According to the exemplary embodiment, the semantic context processor 200 and the context repository 300 may be installed in one apparatus. According to another exemplary embodiment, the semantic context processor 200 and the context repository 300 may be installed in different apparatuses. In this case, various pieces of information and data may be transmitted and received between the semantic context processor 200 and the context repository 300 through a wired/wireless communication.

Hereinafter, for better comprehension and ease of description, the semantic context processor 200 is described by using the smart phone as an example, but the scope of the present invention is not limited thereto. Further, the context repository 300 is described by using a memory space provided in the smart phone, but the scope of the present invention is not also limited thereto. In the examples, the semantic context processor 200 and the context repository 300 will be able to exchange various piece information and various data with each other through a communication in the smart phone. However, according to the exemplary embodiment, the context repository 300 may be provided in a web server. In this case, the semantic context processor 200 and the context repository 300 will be able to exchange various pieces of information and various data with each other through the wired/wireless communication.

Meanwhile, the semantic context processor 200 according to the exemplary embodiment may include a user's location tracking unit 210, an event managing unit 220, a user preference managing unit 230, a location category managing unit 240, a semantic location information managing unit 250, a semantic user needs inferring unit 260, a user context generating unit 270, and a result outputting unit 280.

The user's location tracking unit 210 according to the exemplary embodiment receives information regarding a GPS coordinate value for a current position from a GPS module (not shown) of the smart phone. Meanwhile, the user's location tracking unit 210 reads address information corresponding to the GPS coordinate value from an address storage 328 of a location repository 310 on the basis of the GPS coordinate value for the user's current location. In addition, the user's location tracking unit 210 reads surrounding address information from the address storage 328 within a predetermined distance on the basis of the read address information.

The event managing unit 220 according to the exemplary embodiment manages a predetermined event for each location. That is, the event managing unit 220 manages information regarding an event performed at a predetermined location. The event information may include information regarding a date and a time of the corresponding event, and information regarding a type of the event, and the like. The event information may be stored in the context repository 300 to correspond to the predetermined location. According to the exemplary embodiment, the event information may be downloaded from a web server (not shown) providing the event information.

The user preference managing unit 230 according to the exemplary embodiment manages a user's social relationship, a user's profile, and a user's location visiting history.

The user preference managing unit 230 receives objectives of large classification and middle classification for predetermined locations transferred from the semantic location information managing unit 250. In addition, the user preference managing unit 230 extracts the user's profile (including information regarding an age, an occupation, a school, an interest, and the like of the user). The user preference managing unit 230 extracts the objective most suitable for the user among the objectives of the large classification and the middle classification for the predetermined locations which are received on the basis of the extracted user's profile. In this case, the user's profile is preferably extracted from a user/social relationship repository 320.

Further, the user preference managing unit 230 reads the extracted user's profile and a social relationship list which is a list of people having the social relationship with the user. In this case, the social relationship list is preferably read from the user/social relationship repository 320.

In addition, the user preference managing unit 230 queries a visitation history of other people which is written in the social relationship list for the predetermined locations transferred from the semantic location information managing unit 250. In this case, the visitation history of the other people written in the social relationship list is used when the corresponding information is included in the context repository 300 and can be used after requesting the corresponding information to a web server (not shown) providing the corresponding information to download the visitation history information when the corresponding information is not included in the context repository 300.

The user preference managing unit 230 filters large classification and middle classification of predetermined locations which match between the large classification and the middle classification for the predetermined locations and the visitation history of the other people written in the social relationship list. In this case, the objective most suitable for the user extracted from the user preference managing unit 230 is preferably used for filtering.

In addition, the user preference managing unit 230 extracts predetermined locations which other people visit in the corresponding region by using the user's profile and the visitation history of other people written in the social relationship list on the basis of the GPS coordinate value address information and the surrounding address information. In this case, it is preferable to acquire information regarding the use's profile, the social relationship list, and the visitation history of other people from the user/social relationship repository 320. In addition, in this case, the objective most suitable for the user extracted from the user preference managing unit 230 is preferably used during extraction.

The location category managing unit 240 according to the exemplary embodiment generates a category class for each location. That is, the location category managing unit 240 generates and stores the location category class for large classification and middle classification of the predetermined locations filtered by the user preference managing unit 230. The location category managing unit 240 transfers the location category corresponding to the generated location category class to the user context generating unit 270.

The semantic location information managing unit 250 according to the exemplary embodiment queries category information of each location and manages an objective of each location.

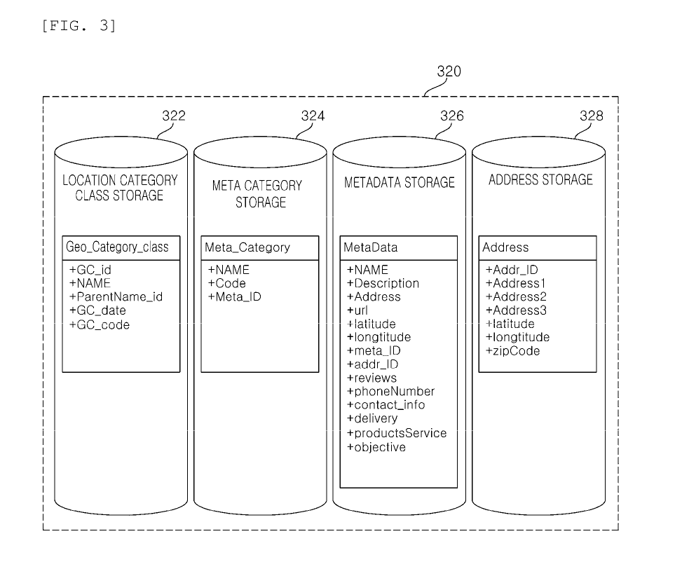

That is, the semantic location information managing unit 250 extracts large classification and middle classification for the predetermined locations that exist in the GPS coordinate value address information and the surrounding address information read from the user's location tracking unit 210. In this case, data of a location category class storage 322 of FIG. 3 is preferably used.

Further, the semantic location information managing unit 250 extracts objectives of the large classification and the middle classification for the predetermined locations that exist in the GPS coordinate value address information and the surrounding address information read from the user's location tracking unit 210. In this case, data of a metadata storage 326 of FIG. 3 is preferably used.

In addition, the semantic location information managing unit 250 transfers the objectives of the large classification and the middle classification for the extracted predetermined locations to the user preference managing unit 230.

The semantic user needs inferring unit 260 according to the exemplary embodiment infers user's needs by using the information regarding each location and user information. That is, the semantic use needs inferring unit 260 extracts a query word or a search word which other people included in the social relationship list search at the corresponding location from a query word/query result repository 330 storing a query word/query result or a search word/search result by referring to the social relationship list read by the user preference managing unit 230, and the GPS coordinate value address information and surrounding address information read by the user's location tracking unit 210. In this case, the objective most suitable for the user extracted from the user preference managing unit 230 is preferably used during extraction.

The semantic user needs inferring unit 260 transfers the extracted query word or search word to the user context generating unit 270.

The user context generating unit 270 according to the exemplary embodiment generates contexts for the social location information, the social category information, and the social keyword information on the basis of the category information and the location information, and the visitation history information. In addition, various contexts generated from the user context generating unit 270 are stored in the context repository 300.

That is, the user context generating unit 270 generates as the user context the social location which is the location which other people having the social relationship visit at the user's current location transferred from the user preference managing unit 230.

That is, the user context generating unit 270 generates as the user context the social category which is a classification which the user is most interested in at the user's current location by using the location category transferred from the location category managing unit 240.

That is, the user context generating unit 270 generates as the user context a social keyword which the user is most interested in at the user's current location by using the query word or search word finally extracted by the semantic user needs inferring unit 260.

A result outputting unit 280 according to the exemplary embodiment provides the social location information, the social category information, and the social keyword information generated from the user context generating unit 270 as necessary.

Meanwhile, the context repository 300 according to the exemplary embodiment of the present invention may include the location repository 310, the user/social relationship repository 320, and the query word/query result repository 330.

The location repository 310 according to the exemplary embodiment stores the location information. The location repository 310 stores location category class information, meta category information, metadata information, and address information.

The user/social relationship repository 320 according to the exemplary embodiment stores the user's profile, the list of people having the social relationship, visitation locations of people having the social relationship, and a user's visitation location.

The query word/query result repository 330 according to the exemplary embodiment stores a query word and a search word and the resulting search result and query result which a user searches at a user's predetermined location.

FIG. 3 is a diagram illustrating an exemplary embodiment of a location repository of FIG. 2.

The location repository 310 according to the exemplary embodiment may include a location category class storage 322, a meta category storage 324, a metadata storage 326, and an address storage 328.

The location category class storage 322 stores category items of large classification and middle classification in a predetermined location or a predetermined region. In the exemplary embodiment, item GC_ID (which is an ID item which can specify the location category), item Name (which is a middle classification item of the location category), item ParentName (which is a large classification item of the location category), and item GC_Code (which is a code item for the location category) are presented as an example.

The meta category storage 324 stores the selected classification category item. In the exemplary embodiment, item Name (a name/title item of the selected classification category), item Code (which is a code item of the selected classification category), and item Meta_ID (which is the Meta ID item for the selected classification category) are presented as an example.

The metadata storage 326 stores various related information for each predetermined location. In the exemplary embodiment, item Name (which is a name/title item of a predetermined location), item Description (which is a description item describing a predetermined location), item Address (which is an address information item of a predetermined location), item URL (which is a URL information item of a predetermined location), item latitude (which is a latitude information item of a predetermined location), item longitude (which is a longitude item of a predetermined location), item Meta_ID (which is a Meta ID item for a predetermined location), item Addr_ID (which is an address information item for an address corresponding to a predetermined location), item review (which is a review/visitation report information item of a visitor or a user who visits a predetermined location), item PhoneNumber (which is a phone number information item of a predetermined location), item Contact_Info (which is a contact/touch information item to a predetermined location), item delivery (which is an information item regarding a delivery of a service or a product provided in a predetermined location), item ProductsService (which is an information item regarding a product or a service provided from a predetermined location), and item objective (which is an information item regarding objectives associated with a predetermined location).

The address storage 328 stores information regarding each predetermined address. In the exemplary embodiment, as the information regarding each address, item Addr_ID (which is an ID granted to the corresponding address), item Address1 (which is an information item regarding the widest administration unit address: e.g., a municipality, a metropolitan city, and a province), item Address2 (which is an information item regarding an administration unit address under Address1: e.g., a city, a county, and a district), item Address3 (which is an information item regarding an administration unit address under Address2: e.g., a street, a dong, a myeon, and a ri), item latitude (which is a latitude information item of the corresponding address), item longitude (which is a longitude information item of the corresponding address), and item zipcode (which is a zipcode information item) are presented as an example.

According to the exemplary embodiment, a code item of the location category class storage 322 and a code item of the meta category storage 324 correspond to each other. Further, the Meta_ID item of the meta category storage 324 and the Meta_ID item of the metadata storage 326 correspond to each other. In addition, the Addr_ID item of the metadata storage 326 and the Addr_ID item of the address storage 328 correspond to each other. When the corresponding items have the same value, a location category class and a meta category, the meta category and metadata, and the metadata and an address are connected to each other.

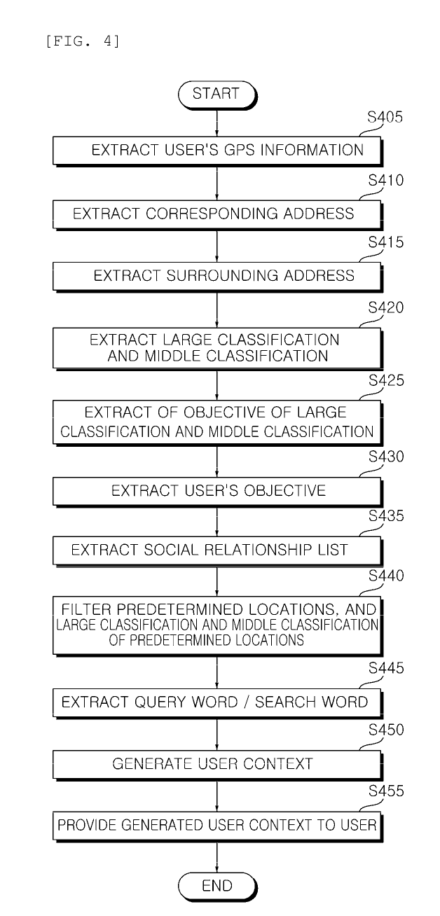

FIG. 4 is a flowchart illustrating a semantic context providing method according to an exemplary embodiment of the present invention.

Hereinafter, a description is made with reference to FIGS. 2, 3, and 4.

First, information on a GPS coordinate value for the user's current location is received to the user's location tracking unit 210 from a GPS module (not shown) of the smart phone (S405).

In addition, on the basis of the GPS coordinate value information for the current location, corresponding address information by the user's location tracking unit 210 is read (S410).

Further, surrounding address information within a predetermined distance on the basis of the read address information is read by the user's location tracking unit 210 (S415).

Large classification and middle classification for predetermined locations which exist within the GPS coordinate value address and surrounding address information read by the user's location tracking unit 210 are extracted by the semantic location information managing unit 250 (S420).

In addition, objectives for the extracted large classification and middle classification are additionally extracted by the semantic location information managing unit 250 (S425).

A user's objective which is an objective most suitable for the user among the objectives for the large classification and the middle classification additionally extracted by the semantic location information managing unit 250 is extracted by the user preference managing unit 230 (S430). In this case, the user's profile will be used.

In addition, the social relationship list of other people having the social relationship with the user is extracted by the user preference managing unit 230 (S435).

Predetermined locations, and large classification and middle classification for the predetermined locations are filtered by the user preference managing unit 230 by querying the visitation history for the predetermined locations which the corresponding other people visit on the basis of the extracted social relationship list (S440).

In addition, a query word or a search word which the corresponding other people query or search is extracted by the semantic user needs inferring unit 260 on the basis of the extracted social relationship list (S445).

Consequently, the predetermined locations, and the large classification and the middle classification for the predetermined locations which are filtered in operation S440 and the query word/search word extracted in operation S445 are provided to the user context generating unit 270 so as to generate the user context (S450).

In addition, the generated user context is provided to the user through the result outputting unit 280 as necessary (S455).

Meanwhile, in the specification of the present invention, the semantic context providing apparatus may be an apparatus including only the semantic context processor, an apparatus including only the context repository, or an apparatus including both the semantic context processor and the context repository.

An apparatus and a method for providing a semantic context according to the present invention can be applied to a portable terminal field such as a smart phone, and the like, an apparatus providing a location-based service, and an apparatus providing a social network service.

As described above, the present invention can be implemented in predetermined other forms without departing from the spirit and essential feature of the present invention. Accordingly, the detailed description should not be limitatively analyzed but considered as exemplification in all viewpoints. The scope of the present invention should be determined by reasonable analysis of the appended claims and all modifications within the equivalent scope are included in the scope of the present invention. Further, claims which have no clear quotation relationship in the appended claims are combined with each other to configure an exemplary embodiment or may be included in a new claim by modification after application.

What is claimed is:

1. An apparatus for providing a semantic context, comprising;
a user's location tracking unit extracting at least one of address information and surrounding address information of the address information on the basis of a user's location;
a user preference managing unit reading a social relationship list which is a list of people having a social relationship with a user;
a semantic user needs inferring unit extracting a query word which people on the read social relationship list query in a region corresponding to at least one of the extracted address information and the extracted surrounding address information; and
a result providing unit providing the extracted query word to the user.

2. The apparatus of claim 1, wherein the user preference managing unit extracts a predetermined location which people on the read social relationship list visit in the region corresponding to at least one of the extracted address information and the extracted surrounding address information, and the result outputting unit provides the extracted predetermined location to the user.

3. The apparatus of claim 2, further comprising:
an event managing unit managing event information for the predetermined location,
wherein the result outputting unit additionally provides the event information for the predetermined location.

4. An apparatus for providing a semantic context, comprising:
a user's location tracking unit extracting at least one of address information and surrounding address information of the address information on the basis of a user's location;
a semantic location information managing unit extracting category classification for a predetermined location which exists in a region corresponding to at least one of the address information and the surrounding address information of the address information and extracting at least one objective of the category classification; and
a user preference managing unit extracting an objective most suitable for a user among at least one objective of the category classification on the basis of the user's profile.

5. The apparatus of claim 4, wherein the user's profile includes at least one piece of information of an age, an occupation, and an interest of the user.

6. A method for providing a semantic context, comprising:
extracting at least one of address information and surrounding address information of the address information on the basis of a user's location;
reading a social relationship list which is a list of people having a social relationship with a user;
extracting information associated with people on the read social relationship list in a region corresponding to at least one of the extracted address information and the extracted surrounding address information; and
providing the extracted information to the user.

7. The method of claim 6, wherein the extracting of the associated information includes extracting a query word which people on the social relationship list query in the region corresponding to at least one of the extracted address information and the extracted surrounding address information.

8. The method of claim 6, wherein the extracting of the associated information includes extracting a predetermined location which people on the social relationship list visit in the region corresponding to at least one of the extracted address information and the extracted surrounding address information.

9. The method of claim 8, further comprising: additionally providing event information for the predetermined location to the user.

10. An apparatus for providing a semantic context, comprising:
a relationship repository storing a social relationship list which is a list of people having a social relationship with a predetermined user; and
a location repository storing predetermined location information, address information corresponding to the predetermined location information, surrounding address information of the address information, and a predetermined location which people on the social relationship list visit in a region corresponding to at least one of the address information and the surrounding address information.

11. The apparatus of claim 10, further comprising:
a query repository storing a query word which people on the read social relationship list query in the region corresponding to at least one of the extracted address information and the extracted surrounding address information.
